(19) United States
(12) Patent Application Publication
(10) Pub. No.: US 2014/0055881 A1
(43) Pub. Date: Feb. 27, 2014

(54) RECORDING REGIONS IN A SHINGLED MAGNETIC HARD DISK DRIVE SYSTEM

(71) Applicant: Daniel Raymond Zaharris, Longmont, CO (US)

(72) Inventor: Daniel Raymond Zaharris, Longmont, CO (US)

(73) Assignee: LSI Corporation

(21) Appl. No.: 13/592,023

(22) Filed: Aug. 22, 2012

(51) Int. Cl. G11B 5/02

(52) U.S. Cl. 360/55; G9B/5.027

(57) ABSTRACT

Described embodiments provide a method of writing data to a storage medium having a plurality of shingled magnetic recording (SMR) regions and a plurality of non-SMR recording regions. A host write request is generated from a hard disk controller coupled to the storage medium and a host device. Data corresponding to the host write request is written to the storage medium in one or more associated non-SMR recording regions. During substantially idle time of the storage medium, data from the non-SMR recording regions is transferred to one or more associated SMR recording regions. Thus, the data corresponding to the host write request is buffered in the associated non-SMR recording regions, avoiding operation latency for read-modify-write (RMW) operations corresponding to data previously written to an SMR recording region.

### CROSS-REFERENCE TO RELATED APPLICATIONS

The subject matter of this application is related to U.S. patent application Ser. Nos. 13/186,174, 13/186,197 and 13/186,213 all filed Jul. 19, 2011, Ser. No. ______, filed on common date herewith having attorney docket number L11-2343US1 (300.377), Ser. No. ______, filed on common date herewith having attorney docket number L12-0040US1 (300.405), and Ser. No. ______, filed on common date herewith having attorney docket number L12-1295US1 (300.401), the teachings of all of which are incorporated herein in their entireties by reference.

### BACKGROUND

Magnetic and optical data storage devices, such as hard disk drives (HDDs) and compact disk drives, are formatted during the manufacturing process with a fixed sector size, sometimes called the native sector size or physical block size. A host device might communicate with the HDD using a different data size, and the host data size is referred to as the host sector size or logical block size. Typical native sector sizes might be 512B, 520B, 528B or 4kB. Typical host sector sizes might be 512B, 520B or 4kB. If the host system logical block size is smaller than the HDD native physical block size, write update operation performance latency might occur when writing data from the host to the HDD, since the larger native sector must be read, modified, and then written back to the disk. This operation is called a read-modify-write (RMW) operation. Ideally the host logical block size matches the HDD physical block size for the best performance.

Shingled Magnetic Recording (SMR) is being developed to increase the recording density of, and therefore increase the capacity of HDDs. In SMR, tracks are written in an overlapping fashion to increase HDD storage densities beyond the capacity limits of traditional hard disk drives HDDs employing conventional perpendicular recording. SMR generally requires fewer technology changes to the recording technology than Bit-Patterned Magnetic Recording (BPMR) and Energy Assisted Magnetic Recording (EAMR). However, physical blocks within an SMR track cannot be updated in place since one or more of the adjacent tracks must be entirely rewritten, causing write performance latency versus conventional magnetic recording. Thus, an RMW operation incurs substantial performance latency in an SMR HDD.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described embodiments provide a method of writing data to a storage medium having a plurality of shingled magnetic recording (SMR) regions and a plurality of non-SMR recording regions. A host write request is generated from a hard disk controller coupled to the storage medium and a host device. Data corresponding to the host write request is written to the storage medium in one or more associated non-SMR recording regions. During substantially idle time of the storage medium, data from the non-SMR recording regions is transferred to one or more associated SMR recording regions. Thus, the data corresponding to the host write request is buffered in the associated non-SMR recording regions, avoiding operation latency for read-modify-write (RMW) operations corresponding to data previously written to an SMR recording region.

### BRIEF DESCRIPTION OF THE DRAWING FIGURES

Other aspects, features, and advantages of the present invention will become more fully apparent from the following detailed description, the appended claims, and the accompanying drawings in which like reference numerals identify similar or identical elements.

FIG. 1 shows a shingled magnetic recording (SMR) system in accordance with described embodiments;

FIGS. 2A and 2B show diagrams of exemplary track arrangement on an SMR storage media of the system shown in FIG. 1;

FIG. 3 shows a diagram of exemplary SMR and non-SMR regions arranged on the SMR storage media of the system shown in FIG. 1;

FIGS. 4A and 4B show diagrams of exemplary sector arrangement on the SMR storage media of the system shown in FIG. 1;

FIG. 5 shows a diagram of exemplary sector arrangement of SMR and non-SMR regions arranged on the SMR storage media of the system shown in FIG. 1;

FIG. 6 shows a flow diagram of an exemplary host write operation process of the system shown in FIG. 1; and

FIG. 7 shows a flow diagram of an exemplary storage media formatting process of the system shown in FIG. 1.

### DETAILED DESCRIPTION

Described embodiments provide a shingled magnetic recording (SMR) hard disk drive (HDD) having negligible or no operation latency for read-modify-write (RMW) operations. The SMR native sector size might be independent of the host sector size. Described embodiments employ SMR read regions and non-SMR write regions. The SMR read regions might employ a variable sector size, or a sector size much larger than the host sector size. Some embodiments might adapt the native sector size of non-SMR write regions to match the host sector size. Thus, the non-SMR write regions might be formatted at a lower density than the SMR read regions. As described herein, SMR read regions might be formatted to optimize for the heads and media employed in the system. For example, heads that are found to be of lower performance might be formatted to employ additional ECC or parity data to recover any sector lost in the SMR read region. SMR read regions might contain larger sector sizes for added format efficiency and larger burst error correction capability. Further, the SMR read regions might be written as compressed data to further increase storage capacity of storage media.

Table 1 summarizes a list of acronyms employed throughout this specification as an aid to understanding described embodiments:

TABLE 1

| | | | |
|---|---|---|---|
| AEQ | Analog Equalizer | AFE | Analog Front End |
| BPI | Bits per Inch | BPMR | Bit-Patterned Magnetic |
| | | | Recording |
| DFE | Decision Feedback | ECC | Error Correction Code |
| | Equalizer | | |
| FC | Fibre Channel | FIR | Finite Impulse Response |
| FFE | Feed Forward Equalizer | HDC | Hard Disk Controller |
| HDD | Hard Disk Drive | IC | Integrated Circuit |
| ISI | InterSymbol Interference | ITI | InterTrack Interference |
| PCI-E | Peripheral Component | RF | Radio Frequency |
| | Interconnect Express | | |
| RMW | Read-Modify-Write | SAS | Serial Attached SCSI |
| SATA | Serial Advanced | SCSI | Small Computer System |
| | Technology Attachment | | Interface |
| SERDES | Serializer/Deserializer | SMR | Shingled Magnetic |
| | | | Recording |
| SNR | Signal-to-Noise Ratio | TPI | Tracks per Inch |
| USB | Universal Serial Bus | VGA | Variable Gain Amplifier |

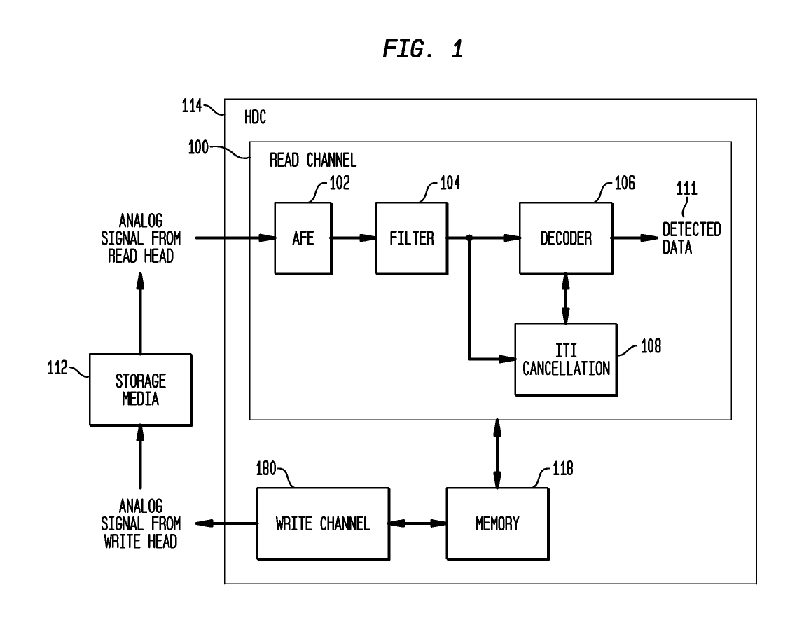

FIG. 1 shows a block diagram of a hard disk drive (HDD) system including storage media 112 and hard disk controller (HDC) 114. HDC 114 might include read channel 100 for reading data from storage media 112, write channel 180 for writing data to storage media 112 and memory 118 for buffering read and write data. Read channel 100 and write channel 180 might include a physical transmission medium, such as a backplane, one or more coaxial cables, one or more twisted pair copper wires, one or more radio frequency (RF) channels, or one or more optical fibers coupled to the drive head in the magnetic recording system. Described embodiments might be employed in serializer-deserializer (SERDES) communication systems or alternative communications systems employing a transmitter and a receiver communicating over a communication channel. Although described herein as a magnetic storage device such as an HDD, storage media 112 might be implemented as any storage media, such as optical storage media such as compact disks or any magnetic storage device. As shown, read channel 100 receives an analog signal from a read head (not shown) that reads data from storage media 112. The analog signal represents an amplitude of a magnetic field induced in the read head by one or more tracks of storage media 112 (e.g., a desired track, N, and intertrack interference (ITI) from one or more adjacent tracks, e.g., N+1, N−1, etc.). HDC 114 might also include a control processor (not shown) to perform various control operations of the HDC.

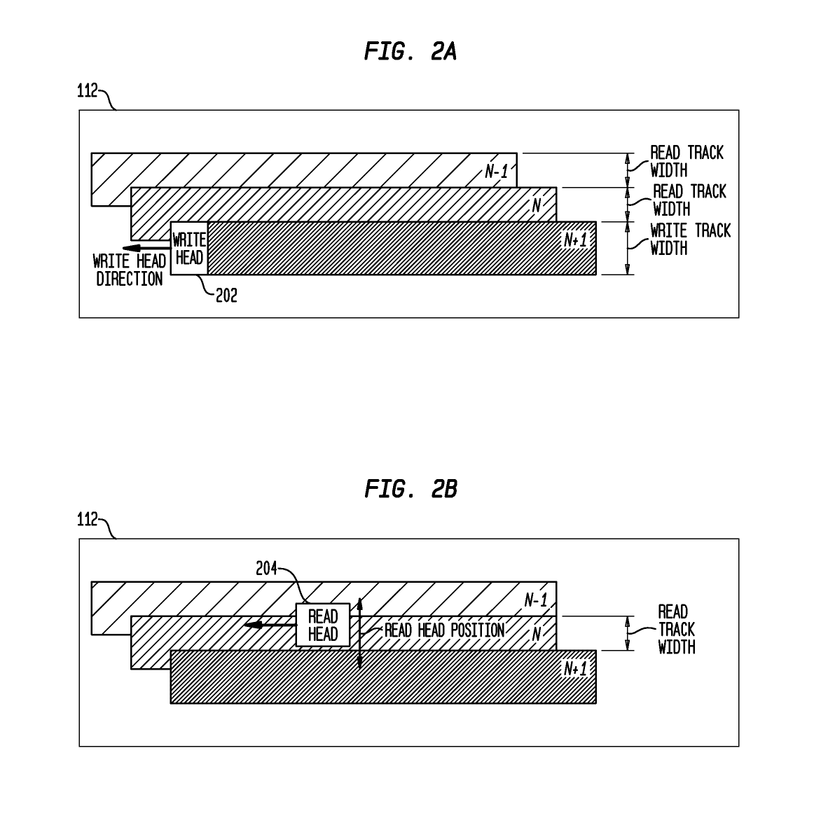

In some embodiments, storage media 112 might store data employing shingled magnetic recording (SMR). In SMR drives, track density is increased by writing tracks successively in an overlapped shingled manner as shown in FIGS. 2A and 2B. As shown in FIGS. 2A and 2B, SMR storage media 112 includes a number of written tracks, shown generally as tracks N−1, N and N+1. As shown in FIG. 2A, track N−1 is written first, followed by track N, followed by track N+1, and so on, by write head 202 in a given direction on SMR media 100. As shown in FIG. 2B, after the shingled tracks are written, track data is stored in an area (“read track width”) that is smaller than the original write area (“write track width”). Thus, in SMR, relatively wider write heads that cover one or more shingled tracks might be employed. Thus, HDD capacity is increased by increasing the tracks per inch (TPI) of the HDD. In SMR, relatively wider write heads that cover one or more shingled tracks might be employed.

However, due to the small read track width, significant ITI from adjacent (or neighboring) tracks might occur during read operations, especially when a read head is employed that is not significantly narrower than the width of the shingled tracks. As shown in FIG. 1, read channel 100 might include ITI cancellation module 108 to cancel ITI from adjacent tracks to the desired read track. ITI cancellation module 108 might operate substantially as described in related U.S. patent application Ser. Nos. 13/186,174, 13/186,197 and 13/186,213 all filed Jul. 19, 2011, Ser. No. ______, filed on common date herewith having attorney docket number L11-2343US1 (300.377), Ser. No. ______, filed on common date herewith having attorney docket number L12-0040US1 (300.405), and Ser. No. ______, filed on common date herewith having attorney docket number L12-1295US1 (300.401), incorporated by reference herein. As shown in FIG. 1, write channel 180 might typically encode, scramble or interleave user data from the host device. Parallel data words might be serialized at a desired clock rate. The serial data is then provided to the write head to be written on storage media 112.

As shown in FIG. 1, the received analog signal from the read head is provided to analog front end (AFE) 102, which might filter or equalize the analog signal, for example by a variable gain amplifier (VGA) to amplify the analog signal and/or a continuous time analog equalizer (AEQ). AFE 102 might also provide sampling of the received analog signal to provide a digital signal to filter 104 that might further condition the signal. Filter 104 might typically be implemented as a finite impulse response (FIR) filter. Other signal conditioning, such as decision feedback equalization (DFE) and feed forward equalization (FFE) (not shown) might employed to reduce intersymbol interference (ISI) between one or more adjacent symbols of the received signal. The filtered sample values are provided to decoder 106 and ITI cancellation module 108.

Decoder 106 decodes, for example by performing error recovery, one or more sectors read from one or more desired read tracks of SMR media 112. In some embodiments, decoder 106 might average the sample values over multiple reads of given sector(s) of desired read track(s). In some other embodiments, decoder 106 might select a relative “most reliable” set of samples from a group of sample sets corresponding to multiple reads of given sector(s) of desired read track(s). If decoder 106 successfully decodes the sector(s), decoder 106 provides the detected data (detected data 111) as the read data for further processing (e.g., to be provided to a host device). If decoder 106 fails to successfully decode the sector(s), decoder 106 provides the detected data to ITI cancellation module 108 to perform ITI cancellation. Thus, ITI cancellation might typically be performed if typical decoding and other decoding retry mechanisms fail to successfully decode a sector.

HDC 114 might be coupled to the host device by a Small Computer System Interface (“SCSI”) link, a Serial Attached SCSI (“SAS”) link, a Serial Advanced Technology Attachment (“SATA”) link, a Universal Serial Bus (“USB”) link, a Fibre Channel (“FC”) link, an Ethernet link, an IEEE 802.11 link, an IEEE 802.15 link, an IEEE 802.16 link, a Peripheral Component Interconnect Express (PCI-E) link, or any other similar interface for connecting a peripheral device to a host device.

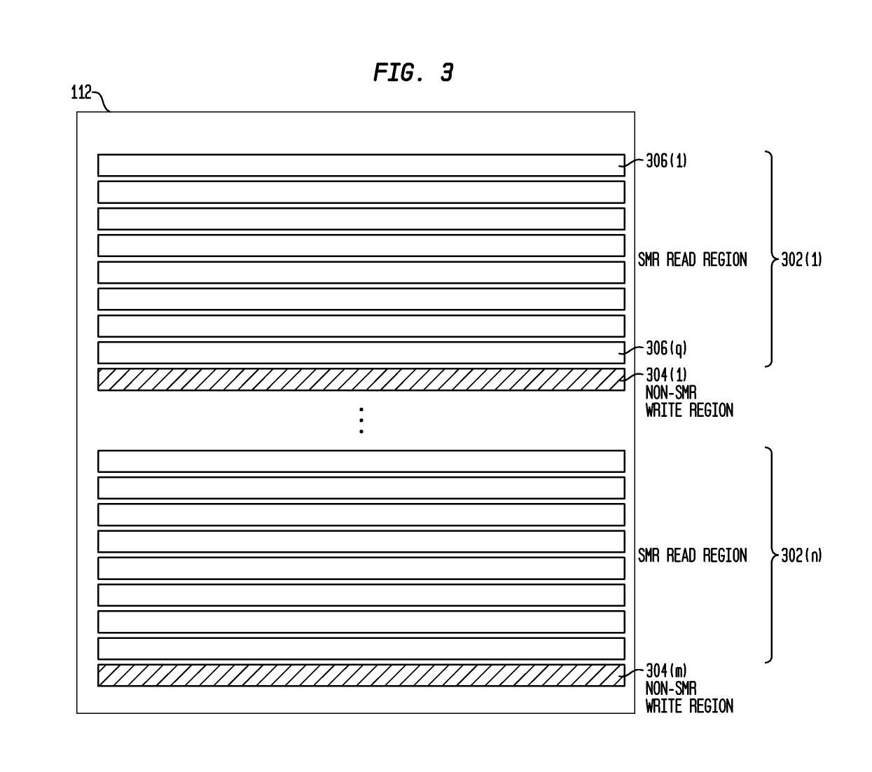

As will be described, SMR regions might be employed such that read-modify-write (RMW) operations are written first to a non-SMR region before being copied into an SMR region at a later time. FIG. 3 shows an exemplary layout of SMR storage media 112. In some embodiments a relatively large portion of the HDD might be implemented as “read-only” format-optimized SMR tracks. Each of the SMR tracks might have a native sector size that is independent of the host sector size. As will be described, the SMR tracks might be optimized for the specific heads and media employed in the system shown in FIG. 1. As shown in FIG. 3, SMR storage media 112 is separated into SMR read regions 302(1)-302(n) and non-SMR write regions 304(1)-304(m). In described embodiments, SMR read regions 302(1)-302(n) each contain a number of SMR tracks, shown as SMR tracks 306(1)-306(q). In some embodiments, each SMR read region 302(1)-302(n) might include a fixed number of SMR tracks (e.g., 10 tracks, etc.), or in other embodiments, SMR read region 302(1)-302(n) might be selected to be a fixed capacity size (e.g., 10MB, etc.). In some embodiments, non-SMR write regions 304(1)-304(m) might be implemented as 3-5% of the total capacity of storage media 112.

In some embodiments, non-SMR write regions 304(1)-304(m) are formatted to have a native sector size that matches the host logical block size. All write operations to write data from the host device to storage media 112 might first be written to one of non-SMR write regions 304(1)-304(m), thus, the host write operation is performed without the performance latency incurred in typical SMR HDDs. Data stored to non-SMR write regions 304(1)-304(m) might be later written in the shingled tracks of SMR read regions 302(1)-302(n). For example, storage media 112 might copy data from non-SMR write regions 304(1)-304(m) to SMR read regions 302(1)-302(n) as a background operation during idle time of storage media 112. In various embodiments, this update operation might be managed by the storage device or by the host device.

Non-SMR write regions 304(1)-304(m) might be relatively smaller than the total capacity of storage media 112 (e.g., 3-5% of total capacity of media 112). In some embodiments non-SMR write regions 304(1)-304(m) might be dispersed across storage media 112 to reduce data access time by reducing head travel distance (both radially and circumferentially on storage media 112) required to traverse to a write region. However, since the capacity of non-SMR write regions 304(1)-304(m) is effectively used to buffer data written to SMR read regions 302(1)-302(n), the size of non-SMR write regions 304(1)-304(m) should not be counted as user data storage capacity of storage media 112. However, in described embodiments, this “lost” capacity might be recovered by increasing the format efficiency of SMR read regions 302(1)-302(n).

Since SMR read regions 302(1)-302(n) are read-only, SMR read regions 302(1)-302(n) might be formatted without regard to the host sector size and, thus, SMR read regions 302(1)-302(n) might have a native sector size much larger than the host sector size. In some embodiments, SMR read regions 302(1)-302(n) might employ a variable sector size. Thus, by employing a larger native sector size in SMR read regions 302(1)-302(n), storage media 112 might gain increased format efficiency, yielding increased drive capacity and improved error correction capability, as well as an improved (increased) signal-to-noise ratio (SNR). Increasing the SNR for the SMR read regions allows corresponding increases in the storage capacity of the SMR read regions (and thus of storage media 112) by allowing data densities to be increased. Additionally, increasing the SNR might improve manufacturing yield for the storage devices.

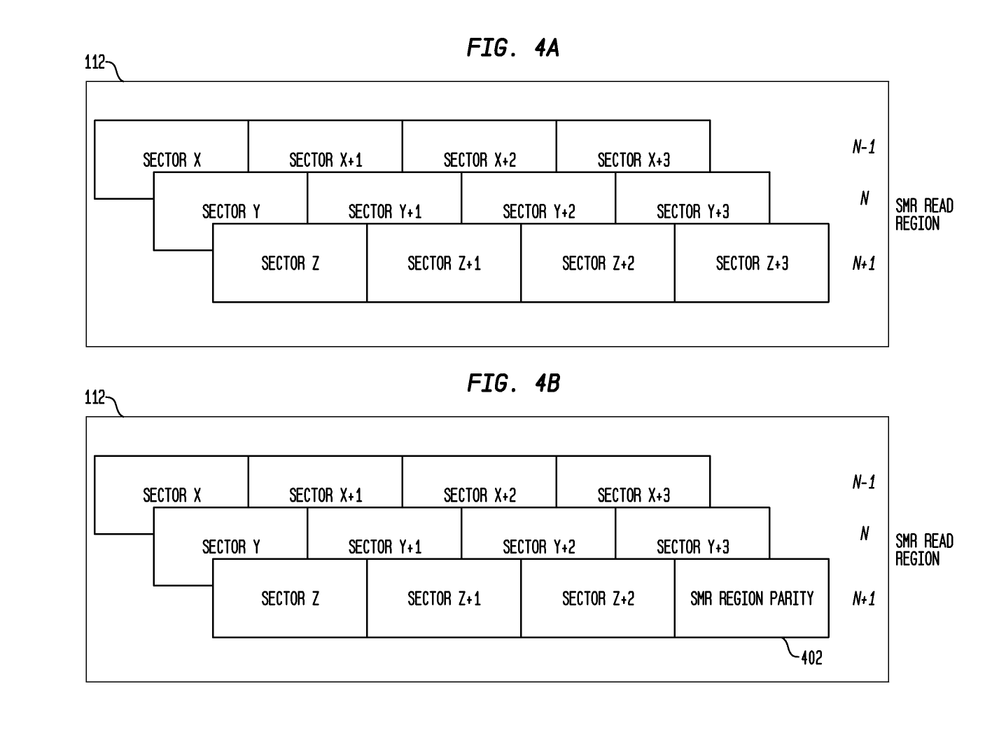

FIGS. 4A and 4B show exemplary diagrams of sector arrangement of SMR read regions 302(1)-302(n) on storage media 112. As shown in FIG. 4A, SMR read regions 302(1)-302(n) might include multiple sectors in each SMR track, where each sector has a native sector size that is larger than the host sector size. As shown in FIG. 4B, SMR read regions 302(1)-302(n) might include one or more additional parity or error correction code (ECC) fields (shown generally as parity field 402 and referred to generally as “parity data”) for increased reliability of the data stored in each SMR read region 302(1)-302(n). Parity field 402 might generally allowed recovery of one or more sectors of user data stored in the SMR read region. Although shown in FIG. 4B as located in a single sector at the end of the SMR read region, parity field 402 might be larger than a single sector and might be located in anywhere throughout the SMR read region.

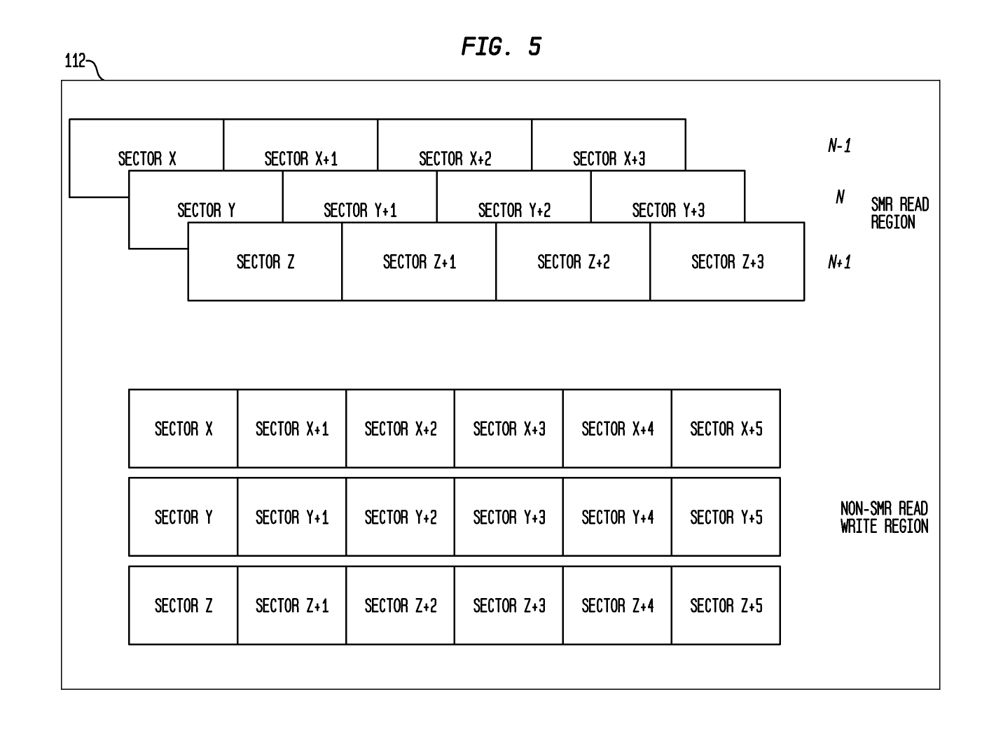

FIG. 5 shows a diagram of sector arrangement of SMR read regions 302(1)-302(n) and non-SMR write regions 304(1)-304(m) on storage media 112. As shown in FIG. 5, non-SMR write regions 304(1)-304(m) might employ a sector size that is generally smaller than the sector size of SMR read regions 302(1)-302(n) on storage media 112. Some embodiments might format the native sector size of non-SMR write regions 304(1)-304(m) to match the host sector size. The non-SMR write regions 304(1)-304(m) might be formatted at a lower density than SMR read regions 302(1)-302(n).

As described herein, by having multiple SMR read regions 302(1)-302(n) and non-SMR write regions 304(1)-304(m) on storage media 112, described embodiments might be able to vary sector size and amount of error correction (e.g., ECC or parity data) in each of the various regions, based on the performance of various read and write heads within the system. For example, if a given head is determined to be relatively weak (e.g., the read head experiences many data recovery errors), described embodiments might reduce at least one of the tracks per inch (TPI) or bits per inch (BPI) within the tracks of one or more of SMR read regions 302(1)-302(n) for that head. Similarly, described embodiments might increase the amount of error correction employed in one or more given regions if a given head is determined to be relatively weak (e.g., the read head experiences many data recovery errors). For example, the amount of ECC or parity data might be increased to enable recovery of entire sectors, tracks or regions, based on the performance of the given head. Thus, as described, embodiments might employ regions of varying density (TPI and/or BPI) and varying error correction capability on the same storage medium. In some embodiments, parity data might not be stored in separate sector(s), and rather might be interleaved with user data and stored along with user data generally throughout the SMR read regions. In some embodiments, additional parity might be added to a given track or a given SMR read region in order to recover entire sectors that might be unrecoverable with sector ECC. In described embodiments, a RMW operation is not required to update parity sectors (e.g., a “super parity sector”) that might be built from all of the sectors on the track, since SMR read regions are updated in the background and the host device does not experience a RMW performance degradation to update parity data.

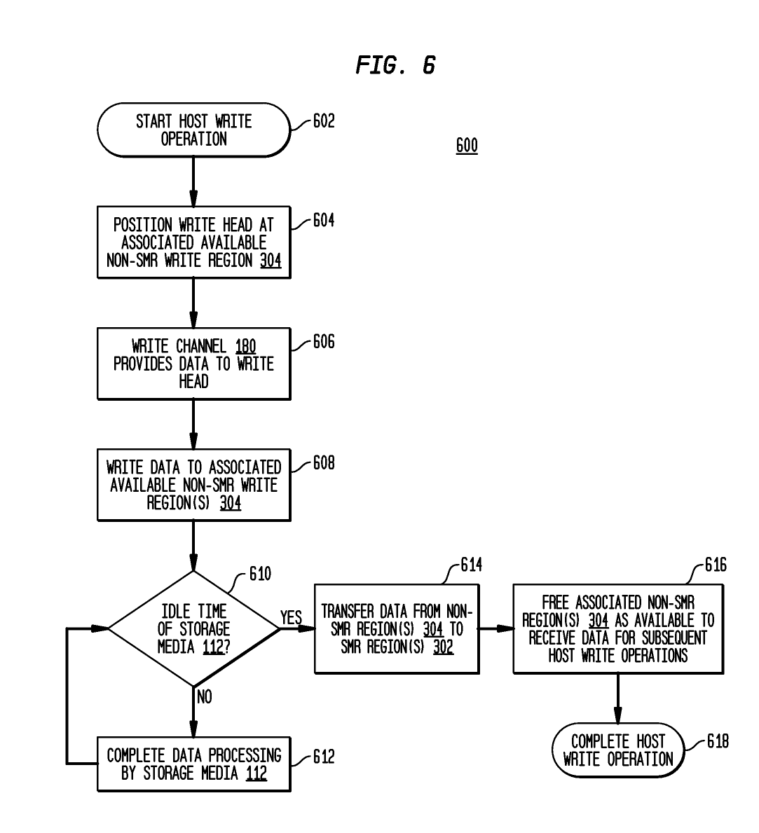

FIG. 6 shows a flow diagram of an exemplary host write operation process 600. At step 602, write channel 180 receives a host write operation. At step 604, HDC 114 requests that storage media 112 position the write head at an available track in a selected one of non-SMR write regions 304. At step 606, write channel 180 provides the data to the write head and at step 608 the write head writes the data to the associated non-SMR write region 304 or, if necessary, multiple associated non-SMR write regions 304. At step 610, if storage media 112 is busy processing any other operations, at step 612, storage media 112 completes processing the other operations until storage media 112 becomes idle.

At step 610, if storage media 112 is idle (e.g., is not busy processing any other operations), then at step 614, storage media 112 reads data from one or more non-SMR write regions 304 (e.g., any non-SMR write region 304 that contains valid data) and writes the data to one or more associated SMR read regions 302. Therefore, no RMW operations need be performed within the SMR regions, and thus described embodiments avoid operation latency for RMW operations corresponding to data previously written to a given SMR recording region 302. At step 616, any of non-SMR write regions 304 that have been transferred to SMR read regions 302 are made available by storage media 112 to receive data for subsequent host write operations. Although not shown in FIG. 6, if a host operation is received by storage media 112 during processing of steps 614 or 616, process 600 might pause processing of steps 614 or 616 until storage media 112 is again idle, in order to process the received host operation. In various embodiments, steps 614 and 616 might be performed by HDC 114, storage media 112, a host device, or some combination thereof.

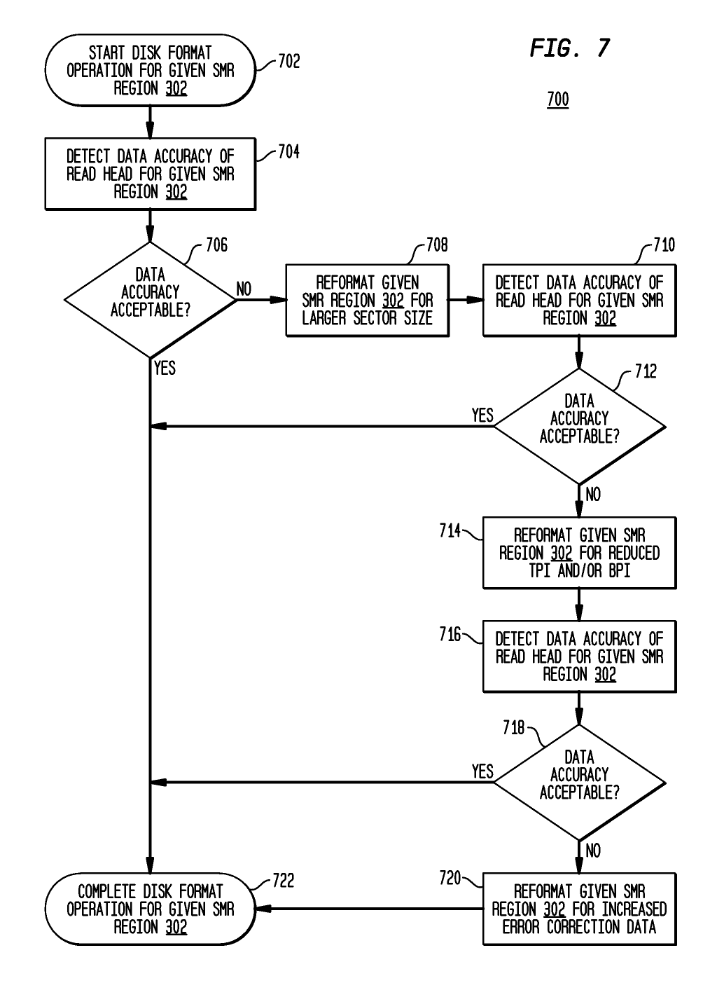

FIG. 7 shows a flow diagram of exemplary storage media formatting process 700. As shown in FIG. 7, SMR read regions 302 might be adaptively formatted to optimize for the heads and media employed in the system. For example, heads that are found to be lower performance might be formatted to employ additional ECC or parity data to recover any sector lost in SMR read regions 302, or SMR read regions 302 might be formatted to contain reduced TPI or BPI, or to contain larger sector sizes for added format efficiency and larger burst error correction capability. At step 702, disk formatting operation 700 is started, for example at a manufacturing test or a first startup of the system shown in FIG. 1. At step 704, the data accuracy and performance of the read head is determined for a given one of SMR regions 302. At step 706, if the data accuracy is acceptable, process 700 completes at step 722.

If, at step 706, the data accuracy of the read head in the given SMR read region 302 is not acceptable, at step 708, the given SMR read region 302 might be reformatted to employ a larger sector size. At step 710, the data accuracy and performance of the read head is determined for the given SMR region 302. At step 712, if the data accuracy is acceptable, process 700 completes at step 722. Otherwise, at step 714, the given SMR read region 302 might be reformatted to employ a reduced TPI and or BPI to relax the accuracy requirements of the read head. At step 716, the data accuracy and performance of the read head is determined for the given SMR region 302. At step 718, if the data accuracy is acceptable, process 700 completes at step 722. Otherwise, at step 720, the given SMR read region 302 might be reformatted to employ increased error correction data (e.g., increased ECC and/or parity data, etc.). At step 722, process 700 completes for the given SMR read region 302. Thus, process 700 might be performed for multiple ones, or all of, SMR read regions 302, and the formatted characteristics of each SMR read region 302 might be set independently of each other (and also independently of the host sector size). Although shown as being reformatted in a given order (e.g., steps 708, 714, and 720) in FIG. 7, described embodiments are not so limited, and the reformatting operations of steps 708, 714, and 720 might be performed in any order. In various embodiments, steps 704-720 might be performed by HDC 114, storage media 112, a host device, or some combination thereof.

Thus, described embodiments provide an SMR HDD having negligible or no operation latency for RMW operations, and the SMR native sector size might be independent of the host sector size. In some embodiments, SMR read regions might employ a variable sector size. Some embodiments might adapt the native sector size of non-SMR write regions to match the host sector size. Thus, the non-SMR write regions might be formatted at a lower density than the SMR read regions. As described herein, SMR read regions might be formatted to optimize for the heads and media employed in the system. For example, heads that are found to be lower performance in the manufacturing process might be formatted to employ additional ECC or parity data to recover any sector lost in the SMR read region. SMR read regions might contain larger sector sizes for added format efficiency and larger burst error correction capability. Further, the SMR read regions might be written as compressed data to further increase storage capacity of storage media 112.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

While embodiments have been described with respect to processes of circuits, including possible implementation as a single integrated circuit, a multi-chip module, a single card, or a multi-card circuit pack, embodiments of the present invention are not so limited. As would be apparent to one skilled in the art, various functions of circuit elements might also be implemented as processing blocks in a software program. Such software might be employed in, for example, a digital signal processor, microcontroller, or general-purpose computer. Such software might be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. Described embodiments might also be manifest in the form of a bitstream or other sequence of signal values electrically or optically transmitted through a medium, stored magnetic-field variations in a magnetic recording medium, etc., generated using a method and/or an apparatus as described herein.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various embodiments.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Unless explicitly stated otherwise, each numerical value and range should be interpreted as being approximate as if the word “about” or “approximately” preceded the value of the value or range. Signals and corresponding nodes or ports might be referred to by the same name and are interchangeable for purposes here.

Transistors are typically shown as single devices for illustrative purposes. However, it is understood by those skilled in the art that transistors will have various sizes (e.g., gate width and length) and characteristics (e.g., threshold voltage, gain, etc.) and might consist of multiple transistors coupled in parallel to get desired electrical characteristics from the combination. Further, the illustrated transistors might be composite transistors.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports might be referred to by the same name and are interchangeable for purposes here.

It will be further understood that various changes in the details, materials, and arrangements of the parts which have been described and illustrated in order to explain the nature of this invention might be made by those skilled in the art without departing from the scope of the invention as expressed in the following claims.

1. A method of writing data to a storage medium having a plurality of shingled magnetic recording (SMR) regions and a plurality of non-SMR recording regions, the method comprising:
generating a host write request from a hard disk controller coupled to the storage medium and a host device;
writing, to the storage medium, data corresponding to the host write request to one or more associated non-SMR recording regions;
copying, within the storage medium during substantially idle time of the storage medium when the storage medium is not processing host requests, data from one or more non-SMR recording regions to one or more associated SMR recording regions,
thereby buffering the data corresponding to the host write request to the one or more associated non-SMR recording regions and avoiding operation latency for read-modify-write (RMW) operations corresponding to data previously written to an SMR recording region.

2. The method of claim 1, further comprising:
detecting performance of a read head of the storage medium for given ones of the plurality of SMR recording regions; and
reformatting one or more operating characteristics of each SMR recording region based on the detected performance corresponding to that SMR recording region.

3. The method of claim 2, wherein the one or more operating characteristics comprise:
a sector size of the SMR recording region, a number of tracks recorded per inch (TPI) within the SMR recording region, a number of bits recorded per inch (BPI) within each track of the SMR recording region, and an amount of error correction data associated with data stored within the SMR recording region.

4. The method of claim 3, wherein the error correction data comprises at least one of error correction codes (ECC) and parity data.

5. The method of claim 3, wherein the sector size of each SMR recording region is independent of a sector size of the non-SMR recording regions, and wherein the sector size of each SMR recording region is also independent of a host sector size of the host device.

6. The method of claim 5, wherein increasing the sector size of each SMR recording region increases the signal-to-noise ratio (SNR) for the recording region, thereby increasing the capacity of the storage medium.

7. The method of claim 3, wherein the number of tracks recorded per inch (TPI) within the SMR recording regions and the number of bits recorded per inch (BPI) within each track of the SMR recording regions are independent of a TPI and a BPI of the non-SMR recording regions.

8. The method of claim 1, further comprising:
setting a sector size of each of the non-SMR recording regions.

9. The method of claim 8, further comprising:
setting the sector size of each of the non-SMR recording regions to match a host sector size of the host device.

10. The method of claim 8, wherein the sector size of the non-SMR recording regions is independent of a sector size of the SMR recording regions.

11. The method of claim 1, further comprising:
compressing, by the storage medium, data from one or more non-SMR recording regions;
transferring, by the storage medium during substantially idle time of the storage medium, the compressed data to one or more associated SMR recording regions.

12. The method of claim 1, wherein, for the method, the plurality of non-SMR recording regions comprises less than 5 percent of the storage capacity of the storage medium.

13. The method of claim 1, wherein the method is implemented by a machine executing program code encoded on a non-transitory machine-readable storage medium.

14. The method of claim 4, further comprising:
employing additional parity data for at least one of a given SMR recording region and a given track within an SMR recording region; and
employing the additional parity data to recover entire sectors that are unrecoverable with sector ECC.

15. The method of claim 14, further comprising:
interleaving ECC and parity with user data in the SMR recording regions, wherein an RMW operation is not performed to update ECC and parity data.

16. A system comprising:
a storage medium comprising a plurality of shingled magnetic recording (SMR) regions and a plurality of non-SMR recording regions;
a hard disk controller coupled to the storage medium and a host device, the hard disk controller configured to:
generate a host write request;
write data corresponding to the host write request to one or more associated non-SMR recording regions of the storage medium; and
copy, within the storage medium during substantially idle time of the storage medium when the storage medium is not processing host requests, data from one or more non-SMR recording regions to one or more associated SMR recording regions,
thereby, the storage medium is configured to buffer the data corresponding to the host write request to the one or more associated non-SMR recording regions and avoid operation latency for read-modify-write (RMW) operations corresponding to data previously written to an SMR recording region.

17. The system of claim 16, further configured to:
detect performance of a read head of the storage medium for given ones of the plurality of SMR recording regions; and
reformat one or more operating characteristics of each SMR recording region based on the detected performance corresponding to that SMR recording region.

18. The system of claim 17, wherein the one or more operating characteristics comprise:
a sector size of the SMR recording region, a number of tracks recorded per inch (TPI) within the SMR recording region, a number of bits recorded per inch (BPI) within each track of the SMR recording region, and an amount of error correction data associated with data stored within the SMR recording region, wherein the error correction data comprises at least one of error correction codes (ECC) and parity data,
wherein the sector size of each SMR recording region is independent of a sector size of the non-SMR recording regions, and wherein the sector size of each SMR recording region is also independent of a host sector size of the host device.

19. The system of claim 18, wherein, as the sector size increases for each SMR recording region, the signal-to-noise ratio (SNR) increases for the recording region, thereby increasing the capacity of the storage medium.

20. The system of claim 18, wherein the number of tracks recorded per inch (TPI) within the SMR recording regions and the number of bits recorded per inch (BPI) within each track of the SMR recording regions are independent of a TPI and a BPI of the non-SMR recording regions.

21. The system of claim 18, further configured to:
set the sector size of each of the non-SMR recording regions to match a host sector size of the host device, wherein the sector size of the non-SMR recording regions is independent of a sector size of the SMR recording regions.

22. The system of claim 16, further configured to:
compress data from one or more non-SMR recording regions; and
transfer, during substantially idle time of the storage medium, the compressed data to one or more associated SMR recording regions.

23. The system of claim 16, wherein the plurality of non-SMR recording regions comprise less than 5 percent of the storage capacity of the storage medium.

24. The system of claim 16, wherein:
the write data is provided from a host device by at least one of a Small Computer System Interface (“SCSI”) link, a Serial Attached SCSI (“SAS”) link, a Serial Advanced Technology Attachment (“SATA”) link, a Universal Serial Bus (“USB”) link, a Fibre Channel (“FC”) link, an Ethernet link, an IEEE 802.11 link, an IEEE 802.15 link, an IEEE 802.16 link, and a Peripheral Component Interconnect Express (PCI-E) link; and
the hard disk controller is implemented as an integrated circuit chip.

25. The system of claim 18, further configured to:
employ additional parity data for at least one of a given SMR recording region and a given track within an SMR recording region; and
employ the additional parity data to recover entire sectors that are unrecoverable with sector ECC.

26. The system of claim 25, further configured to:
interleave ECC and parity with user data in the SMR recording regions, wherein an RMW operation is not performed to update ECC and parity data.
